(19) United States
(12) Patent Application Publication
(10) Pub. No.: US 2025/0115103 A1
(43) Pub. Date: Apr. 10, 2025

(54) DOOR SUPPORT DEVICE

(71) Applicant: AISIN CORPORATION, Kariya (JP)

(72) Inventor: Atsuyuki MASUDA, Kariya-shi (JP)

(73) Assignee: AISIN CORPORATION, Kariya (JP)

(21) Appl. No.: 18/892,629

(22) Filed: Sep. 23, 2024

(30) Foreign Application Priority Data
Oct. 5, 2023 (JP) 2023-173626
Mar. 19, 2024 (JP) 2024-044014

(51) Int. Cl. B60J 5/06; E05B 15/02; E05B 83/40

(52) U.S. Cl. CPC B60J 5/06; E05B 15/0205; E05B 83/40

(57) ABSTRACT

PROBLEM: To provide a door support device that can suppress narrowing of space in a width direction of a vehicle due to the door support device.

SOLUTION: The door support device includes a striker unit to be installed in a vehicle body, a door bracket extending inward in the width direction from a slide door, and a lock mechanism to be supported by the door bracket. The striker unit includes a striker to be displaced between a retracted position and a deployed position. The lock mechanism restrains the slide door to the vehicle body by engaging with the striker located at the deployed position when the slide door is located at a fully open position.

### CROSS REFERENCE TO RELATED APPLICATIONS

This application is based on and claims priority under 35 U.S.C. § 119 to Japanese Patent Application 2023-173626, filed on Oct. 5, 2023, and Japanese Patent Application 2024-044014, filed on Mar. 19, 2024, the entire content of which is incorporated herein by reference.

### TECHNICAL FIELD

This disclosure generally relates to a door support device.

### BACKGROUND DISCUSSION

JP2009-102862A describes a vehicle including a vehicle body with a door opening and a slide door that opens and closes the door opening. The vehicle body includes a striker shaft disposed near a lower end, as well as, near a back end of the door opening. The slide door includes a door body, a lower arm extending inward in a width direction from near the lower end as well as near a front end of the door body, and a lock mechanism disposed at a tip of the lower arm. When the slide door is disposed at a fully open position of fully opening the door opening, the lock mechanism engages with the striker shaft. Thus, the slide door is restrained to the vehicle body at the fully open position.

In a vehicle as described above, the vehicle body has a space for avoiding interference with the lower arm and the lock mechanism when the slide door opens and closes the door opening. Therefore, in such a vehicle, an interior space of the vehicle, a space under a floor of the vehicle, and the like may become narrower in the width direction in order to provide the space described above.

A need thus exists for a door support device, which is not susceptible to the drawback mentioned above.

### SUMMARY

A door support device that solves the problem described above is a door support device applied to a vehicle including a vehicle body with a door opening on a side in a width direction, and a slide door that opens and closes the door opening, wherein the slide door opens and closes the door opening by moving between a fully closed position of fully closing the door opening and a fully open position that is displaced from the fully closed position outward in the width direction and in a front-back direction and fully opens the door opening, the door support device includes a striker unit to be installed in the vehicle body, a door bracket extending inward in the width direction from the slide door, and a lock mechanism to be supported by the door bracket, the striker unit includes a striker to be displaced between a retracted position where the striker is stored against the vehicle body and a deployed position where the striker is deployed outward in the width direction from the retracted position, the striker is placed at the retracted position when the slide door is located at the fully closed position and at the deployed position when the slide door is located at the fully open position, and the lock mechanism restrains the slide door to the vehicle body by engaging with the striker located at the deployed position when the slide door is located at the fully open position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle equipped with a door support device according to a first embodiment;

FIG. 2 is a plan view of a lower rail, a lower hinge unit, and a striker unit according to the first embodiment;

FIG. 3 is an exploded perspective view of the lower rail and lower hinge unit according to the first embodiment;

FIG. 4 is an exploded perspective view of the lower hinge unit according to the first embodiment;

FIG. 5 is a plan view of a lock mechanism with some component parts omitted in the first embodiment;

FIG. 6 is a perspective view of the striker unit according to the first embodiment;

FIG. 7 is a perspective view of the striker unit according to the first embodiment;

FIG. 8 is a plan view illustrating an action of the door support device according to the first embodiment;

FIG. 9 is a plan view illustrating the action of the door support device according to the first embodiment;

FIG. 10 is a plan view illustrating the action of the door support device according to the first embodiment;

FIG. 11 is a plan view illustrating the action of the door support device according to the first embodiment;

FIG. 12 is a plan view illustrating the action of the door support device according to the first embodiment;

FIG. 13 is a plan view illustrating a lower rail, a lower hinge unit, and a striker unit according to a second embodiment;

FIG. 14 is an exploded perspective view of the lower hinge unit according to the second embodiment;

FIG. 15 is a perspective view of the striker unit according to the second embodiment;

FIG. 16 is a perspective view of the striker unit according to the second embodiment;

FIG. 17 is a plan view illustrating an action of the door support device according to the second embodiment;

FIG. 18 is a plan view illustrating the action of the door support device according to the second embodiment;

FIG. 19 is a plan view illustrating the action of the door support device according to the second embodiment;

FIG. 20 is a plan view illustrating the action of the door support device according to the second embodiment;

FIG. 21 is a plan view illustrating the action of the door support device according to the second embodiment; and

FIG. 22 is a plan view illustrating the action of the door support device according to the second embodiment.

### DETAILED DESCRIPTION

### First Embodiment

A first embodiment of a vehicle equipped with a door support device is described below. The vehicle of the first embodiment is a battery electric vehicle (BEV) equipped with a large battery under the floor.

### Configuration of the First Embodiment

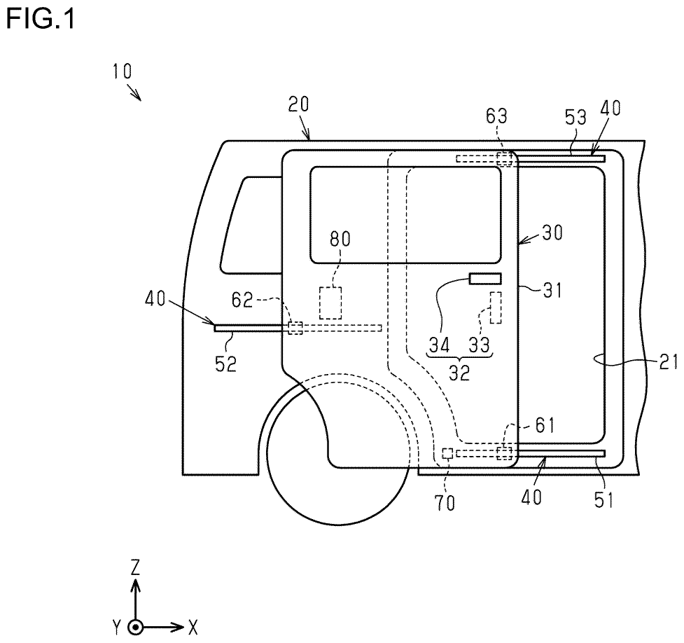

As illustrated in FIG. 1, a vehicle 10 includes a vehicle body 20, a slide door 30, a door support device 40, and a door drive device 80.

In the following description, the width direction of the vehicle 10, the front-back direction of the vehicle 10, and the up-down direction of the vehicle 10 are respectively referred to as the width direction, the front-back direction, and the up-down direction. In the drawings, the front-back direction is the direction in which the X axis extends, the width direction is the direction in which the Y axis extends, and the up-down direction is the direction in which the Z axis extends. In the width direction, the direction toward the center of the vehicle 10 is called inward, and the direction away from the center of the vehicle 10 is called outward.

### Vehicle Body 20

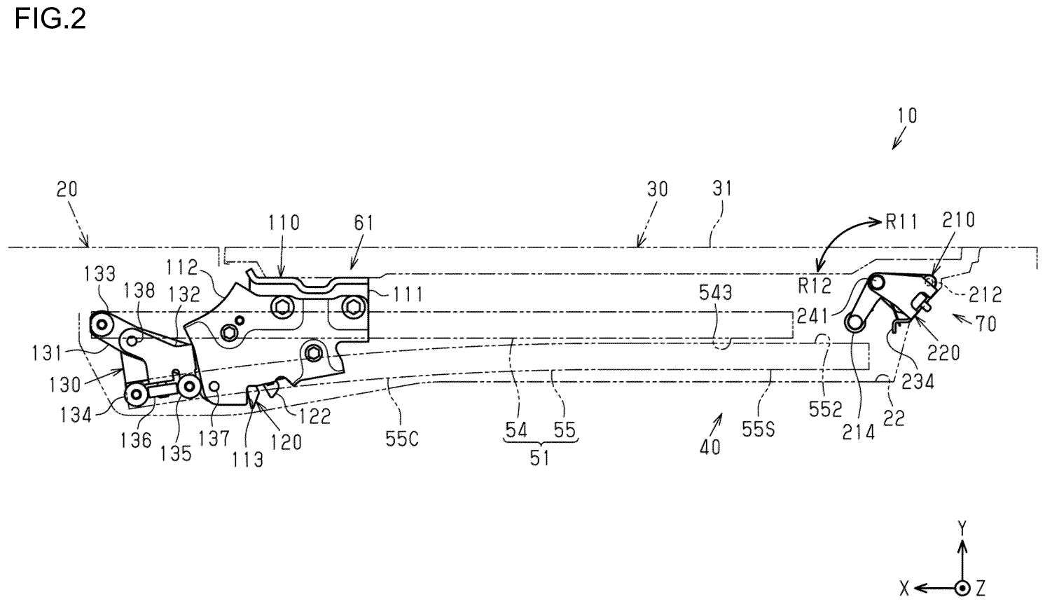

As illustrated in FIGS. 1 and 2, the vehicle body 20 has a door opening 21 and a housing space 22. As illustrated in FIG. 1, the door opening 21 is open on a side of the vehicle body 20 in the width direction. The door opening 21 has a rectangular shape with the front-back direction as the short direction and the up-down direction as the long direction in a side view in the width direction. The door opening 21 is an area through which a user entering and exiting the back seat passes. As illustrated in FIG. 2, the housing space 22 is open on a side of the vehicle body 20 in the width direction. The housing space 22 is located below the door opening 21. The housing space 22 is space for housing a lower rail 51 and a lower hinge unit 61, which will be described later.

### Slide Door 30

As illustrated in FIG. 1, the slide door 30 has a door body 31 and a door handle 32. The door body 31 is shaped according to the door opening 21. The slide door 30 operates between a fully closed position that fully closes the door opening 21 and a fully open position that fully opens the door opening 21. The door handle 32 is provided on the door body 31. The door handle 32 is operated by a user when opening and closing the slide door 30. The door handle 32 includes an inside door handle 33 provided on the inside of the door body 31 and an outside door handle 34 provided on the outside of the door body 31.

### Door Support Device 40

As illustrated in FIG. 1, the door support device 40 includes lower, center, and upper rails 51, 52, 53, lower, center, and upper hinge units 61, 62, 63, and a striker unit 70.

### Lower Rail 51

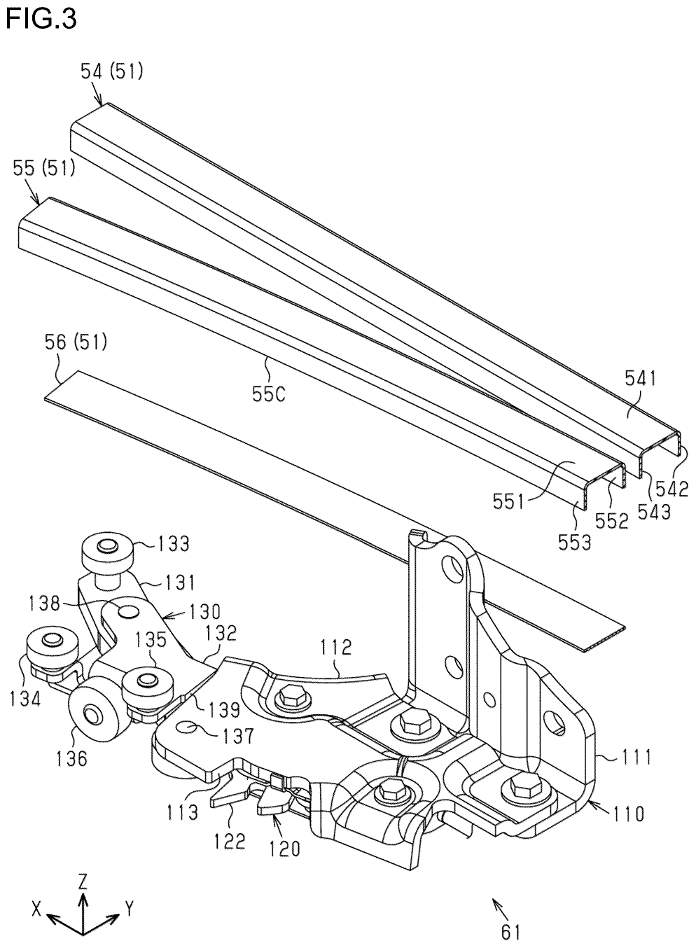

As illustrated in FIG. 1, the lower rail 51 is fixed below the door opening 21 in the vehicle body 20. Although not illustrated in the drawings, the lower rail 51 is fixed to the vehicle body 20 using bolts or other fastening members. As illustrated in FIGS. 2 and 3, the lower rail 51 has a first rail 54, a second rail 55, and a support plate 56. The lower rail 51 corresponds to the “guide rail.”

As illustrated in FIG. 2, the first rail 54 extends in a straight line in a plan view from above. In the first rail 54, the front-back direction is the long direction. As illustrated in FIG. 3, the first rail 54 has an upper wall 541 and two side walls 542, 543. In the upper wall 541, the up-down direction is the thickness direction. The two side walls 542, 543 extend downward from both ends in the width direction of the upper wall 541. In the two side walls 542, 543, the width direction is the thickness direction. The two side walls 542, 543 extend parallel to each other.

As illustrated in FIG. 2, the second rail 55 includes a straight section 55S that is straight and a curved section 55C that curves in an arc shape in a plan view from above. In the straight section 55S, the front-back direction is the long direction. The curved section 55C is gently curved inward in the width direction as the curved section 55C advances forward from the front end of the straight section 55S. As illustrated in FIG. 3, the straight section 55S and the curved section 55C have an upper wall 551 and two side walls 552, 553. In the upper wall 551, the up-down direction is the thickness direction. The two side walls 552, 553 extend downward from both ends in the width direction of the upper wall 551. The two side walls 552, 553 intersect the width direction. The two side walls 552, 553 extend parallel to each other. The support plate 56 is plate-shaped. The support plate 56 has a shape similar to the upper wall 551 of the second rail 55 in a plan view from above. In other words, the support plate 56 has the shape of the upper wall 551 of the second rail 55 projected in the up-down direction.

The first and second rails 54, 55 and the support plate 56 are housed in the housing space 22 of the vehicle body 20. Within the housing space 22, the first rail 54 is located outward in the width direction than the second rail 55. As such, the distance between the side wall 543 of the first rail 54 and the side wall 552 of the curved section 55C of the second rail 55 becomes narrower as the first and second rails 54, 55 advance backward. The front end of the first rail 54 is located forward of the front end of the second rail 55. Whereas, the back end of the first rail 54 is located forward of the back end of the second rail 55. The support plate 56 is located below the second rail 55.

### Lower Hinge Unit 61

As illustrated in FIGS. 2 and 3, the lower hinge unit 61 includes a door bracket 110, a lock mechanism 120, and a guide mechanism 130.

### Door bracket 110

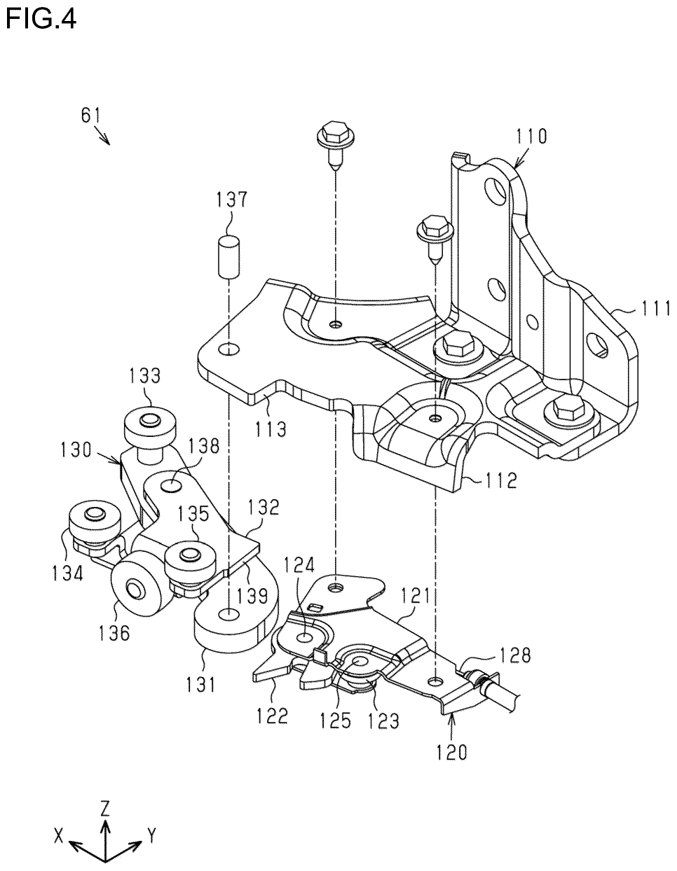

As illustrated in FIGS. 3 and 4, the door bracket 110 is formed, for example, by press-processing a metal sheet. The door bracket 110 has a first portion 111 with the width direction as the thickness direction and a second portion 112 with the up-down direction as the thickness direction. The first portion 111 is bent with respect to the second portion 112. In this respect, the door bracket 110 is L-shaped in a front view in the front-back direction. The first portion 111 is a portion fixed to the inner surface of the slide door 30. The second portion 112 is a portion that supports the lock mechanism 120 and the guide mechanism 130. The second portion 112 has a rotation regulating part 113 that can engage with the striker unit 70. The rotation regulating part 113 is a backward-facing surface in the second portion 112.

While the door bracket 110 is configured with the two members in the first embodiment, the door bracket 110 may instead be configured with one member. In a state where the first portion 111 is fixed to the slide door 30, the second portion 112 extends inward in the width direction. In this respect, the door bracket 110 can be said to extend inward in the width direction from the slide door 30.

### Lock Mechanism 120

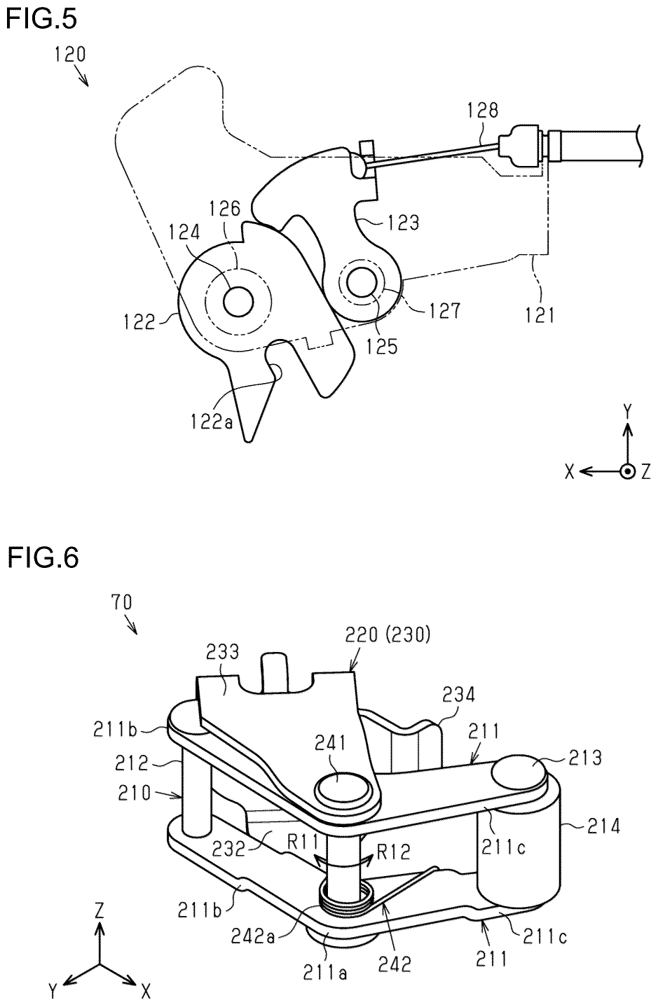

As illustrated in FIGS. 4 and 5, the lock mechanism 120 has a housing 121, a latch 122, a pole 123, a latch support shaft 124, a pole support shaft 125, a latch spring 126, a pole spring 127, and a release cable 128.

The housing 121 is formed, for example, by press-processing a metal sheet. The housing 121 is a part to be fixed to the door bracket 110, as well as, a part to which component parts of the lock mechanism 120 are attached. In the first embodiment, the housing 121 is fixed to the underside of the second portion 112 of the door bracket 110 via a bolt or other fastening members.

The latch 122 is disc-shaped. The latch 122 has an engagement groove 122a extending in a direction orthogonal to the plate thickness direction. The latch 122 is supported by the housing 121 via the latch support shaft 124. Thus, the latch 122 is rotatable about an axis line extending in the up-down direction between a full latch position in which the latch 122 can engage with the striker unit 70 and an unlatch position in which the latch 122 cannot engage with the striker unit 70. The latch 122 is also energized by the latch spring 126. The direction of the force of the latch spring 126 is the direction in which the latch 122 is caused to move from the full latch position to the unlatch position.

The pole 123 is hook-shaped. The pole 123 is supported by the housing 121 via the pole support shaft 125. Thus, the pole 123 is rotatable about an axis line extending in the up-down direction. The pole 123 is also energized by the latch spring 126. Specifically, the pole 123 is energized in a direction where the tip of the pole 123 is caused to contact the latch 122. By engaging with the latch 122 located at the full latch position, the pole 123 restricts the latch 122 from rotating from the full latch position to the unlatch position.

One end of the release cable 128 is connected to the pole 123 and the other end of the release cable 128 is connected to the door handle 32. When the door handle 32 is operated, the release cable 128 is pulled by the door handle 32. Therefore, when the door handle 32 is operated, the pole 123 rotates in the opposite direction of the direction of the force of the pole spring 127. In other words, the pole 123 rotates in the direction away from the latch 122. Note that the vehicle 10 may be equipped with a remote control device that can relay power between the cable connected to the door handle 32 and the cable connected to the pole 123.

### Guide Mechanism 130

As illustrated in FIG. 4, the guide mechanism 130 has a connecting arm 131, a roller support 132, a first guide roller 133, two second guide rollers 134, 135, a support roller 136, and two connecting shafts 137, 138.

The connecting arm 131 is a link connecting the door bracket 110 and the roller support 132. The base end of the connecting arm 131 rotatably supports the first guide roller 133. The first guide roller 133 is rotatable about an axis line extending in the up-down direction. The tip of the connecting arm 131 is connected to the door bracket 110 by the connecting shaft 137 having the up-down direction as the axis direction. Thus, the connecting arm 131 can rotate relative to the door bracket 110 about an axis line extending in the up-down direction.

The roller support 132 is formed, for example, by press-processing a metal sheet. The roller support 132 has a pressing part 139 that presses the striker unit 70. In the first embodiment, the pressing part 139 is a surface located at the back end of the roller support 132. The roller support 132 rotatably supports the two second guide rollers 134, 135 and the support roller 136. The two second guide rollers 134, 135 are rotatable about an axis line extending in the up-down direction. The support roller 136 can rotate about an axis line extending in a direction orthogonal to the up-down direction. In a plan view in the up-down direction, the support roller 136 is located between the two second guide rollers 134, 135.

The roller support 132 is connected to the connecting arm 131 by the connecting shaft 138 having the up-down direction as the axis direction. Thus, the roller support 132 can rotate relative to the connecting arm 131 about an axis line extending in the up-down direction. The connecting arm 131 is connected to the roller support 132 at a connecting site closer to the base end of the connecting arm 131 than to the tip of the connecting arm 131.

As illustrated in FIG. 1, the lower hinge unit 61 is fixed to the lower front end of the slide door 30. Specifically, the first portion 111 of the door bracket 110 of the lower hinge unit 61 is fixed to the lower front end of the slide door 30.

As illustrated in FIGS. 2 and 3, the lower hinge unit 61 is engaged with the first and second rails 54, 55 and the support plate 56. Specifically, the first guide roller 133 is in contact with the first rail 54. Thus, the first guide roller 133 can roll against the first rail 54 of the lower rail 51. The two second guide rollers 134, 135 are in contact with the second rail 55, and the support roller 136 is in contact with the support plate 56. Thus, the two second guide rollers 134, 135 and the support roller 136 can roll against the second rail 55 of the lower rail 51. In this way, the lower hinge unit 61, that is, the guide mechanism 130, can move along the lower rail 51.

As illustrated in FIGS. 2 and 3, in the lower hinge unit 61, the first guide roller 133 and the two second guide rollers 134, 135 are in contact with the first rail 54 and the second rail 55 in the width direction. In this respect, the first guide roller 133 and the two second guide rollers 134, 135 are configured to fix the position of the lower end of the slide door 30 in the width direction. On the other hand, in the lower hinge unit 61, the support roller 136 is in contact with the support plate 56 from above. In this respect, the support roller 136 is configured to support the dead weight of the slide door 30.

### Striker Unit 70

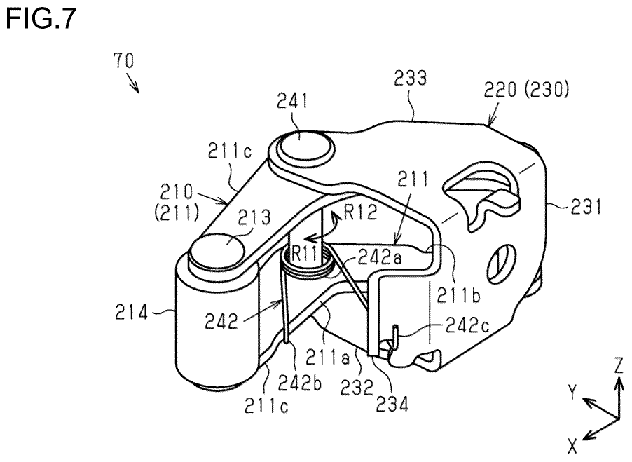

As illustrated in FIGS. 6 and 7, the striker unit 70 includes a striker 210 and a striker support part 220.

The striker 210 has two links 211, a striker shaft 212, a fixed shaft 213, and a receiving part 214. The two links 211 have the same shape. The two links 211 are preferably constructed of a rigid material such as a metallic material. Each of the links 211 has a base 211a and a first arm 211b and a second arm 211c extending in different directions from the base 211a. The first arm 211b and the second arm 211c are of equal length. The striker shaft 212 and the fixed shaft 213 have cylindrical shapes. The striker shaft 212 and the fixed shaft 213 are preferably constructed of a rigid material such as a metallic material. The striker shaft 212 and the fixed shaft 213 may be similarly constructed. The outer diameter of the striker shaft 212 is slightly smaller than the width of the engagement groove 122a of the latch 122 of the lock mechanism 120. The striker shaft 212 connects the tips of the first arms 211b of the two links 211. The fixed shaft 213 connects the tips of the second arms 211c of the two links 211. The receiving part 214 has a cylindrical shape. The receiving part 214 is preferably constructed of a material that has a lower elastic modulus than a metallic material and that can easily absorb shock. For example, the receiving part 214 is preferably constructed of an elastomer such as rubber or resin having moderate elasticity. The receiving part 214 is supported by the fixed shaft 213. In the first embodiment, the receiving part 214 is a roller that can rotate about the fixed shaft 213. That is, the receiving part 214 can rotate about an axis line extending in the same direction as the axis line of rotation of the striker 210. In other embodiments, the receiving part 214 may be supported non-rotatably about the fixed shaft 213. In this case, the friction coefficient between the receiving part 214 and the pressing part 139 is preferably small.

The striker support part 220 has a support bracket 230, a support shaft 241, and an energizing member 242. The support bracket 230 is formed, for example, by press-processing a metal sheet. The support bracket 230 has a fixed wall 231, a lower wall 232, an upper wall 233, and a regulating wall 234. The fixed wall 231 has a rectangular shape in a front view in the thickness direction. The fixed wall 231 is a portion that is fixed to the vehicle body 20. The fixed wall 231 is fixed to the vehicle body 20, for example, using a bolt or other fastening members. The lower wall 232 extends from the lower end of the fixed wall 231 in the thickness direction of the fixed wall 231. On the other hand, the upper wall 233 extends from the upper end of the fixed wall 231 in the thickness direction of the fixed wall 231. In other words, the lower wall 232 and the upper wall 233 are bent from the fixed wall 231. The direction in which the lower wall 232 and the upper wall 233 extend relative to the fixed wall 231 is the same direction. The regulating wall 234 extends from the side end of fixed wall 231. The regulating wall 234 is bent from the fixed wall 231. The regulating wall 234 is bent in an L-shape in a plan view from above. The regulating wall 234 corresponds to a “regulating part.”

The support shaft 241 has a cylindrical shape. Both ends of the support shaft 241 in the axial direction are respectively fixed to the tip of the lower wall 232 and the tip of the upper wall 233. The support shaft 241 has the up-down direction as the axial direction. The support shaft 241 rotatably supports the striker 210. Specifically, the support shaft 241 rotatably supports the striker 210 by passing through the bases 211a of the two links 211 of the striker 210 in the thickness direction. Thus, the axis line of the support shaft 241 is the axis line of rotation of the striker 210. In the first embodiment, the distance from the axis line of rotation of the striker 210 to the axis line of the striker shaft 212 and the distance from the axis line of rotation of the striker 210 to the axis line of the fixed shaft 213 are the same. The axis line of the fixed shaft 213, which is the center of rotation of the receiving part 214, is located inward in the width direction from the axis line of the support shaft 241, which is the center of rotation of the striker 210.

The energizing member 242 is a torsion spring that energizes the striker 210. The support shaft 241 has a coil part 242a through which the energizing member 242 is placed. The first end 242b of the energizing member 242 is engaged with the striker 210, and the second end 242c of the energizing member 242 is engaged with the support bracket 230. Thus, the energizing member 242 energizes the striker 210 in the first rotational direction R11. The striker 210, which is energized in the first rotational direction R11, is fixed in the position by the links 211 contacting the fixed wall 231 of the support bracket 230.

As illustrated in FIGS. 1 and 2, the striker unit 70 is located behind the lower rail 51. The receiving part 214 of the striker 210 is located at a position advanced backward from the back end of the first rail 54 of the lower rail 51 and outward in the width direction from the back end of the second rail 55 of the lower rail 51. In the striker 210, the first arm 211b of the link 211 extends backward and the second arm 211c of the link 211 extends inward in the width direction as the second arm 211c advances forward. The striker unit 70 is located at the same height as the lock mechanism 120 of the lower hinge unit 61.

### Center Rail 52 and Upper Rail 53

As illustrated in FIG. 1, the center rail 52 is fixed behind the back end of the door opening 21 in the vehicle body 20. The center rail 52 is located below the upper rail 53 and above the lower rail 51. The upper rail 53 is fixed above the upper end of the door opening 21 in the vehicle body 20. The center rail 52 and the upper rail 53 have a long direction in the front-back direction.

The center rail 52 and the upper rail 53 preferably have a section that extends straight and a section that curves in an arc shape in a plan view from above. For example, the center rail 52 and upper rail 53 may have similar shapes to the second rail 55 of the lower rail 51.

### Center Hinge Unit 62 and Upper Hinge Unit 63

As illustrated in FIG. 1, the center hinge unit 62 is fixed near the back end, as well as, near the center in the up-down direction of the slide door 30. The upper hinge unit 63 is fixed near the front end, as well as, near the upper end of the slide door 30. The center hinge unit 62 and the upper hinge unit 63 preferably have a configuration corresponding to the door bracket 110 and the guide mechanism 130 of the lower hinge unit 61. Here, the configuration corresponding to the guide mechanism 130 may not have a configuration corresponding to the connecting arm 131. The center hinge unit 62 is movably engaged with the center rail 52. Similarly, the upper hinge unit 63 is movably engaged with the upper rail 53.

### Door Drive Device 80

The door drive device 80 drives the slide door 30. For example, the door drive device 80 drives the slide door 30 by transmitting the power of an electric motor to the slide door 30 via a power transmission member such as a cable and a wire. The door drive device 80 causes the slide door 30 to perform opening operation toward the fully open position or causes the slide door 30 to perform closing operation toward the fully closed position in response to the operation of the door handle 32 by a user.

### Other Configurations

The lock mechanism 120 of the door support device 40 is a full-closed lock that restrains the slide door 30 to the vehicle body 20 at the fully closed position. Although omitted from the description, the door support device 40 preferably has a full-closed lock that restrains the slide door 30 to the vehicle body 20 at the fully closed position.

### Action of the First Embodiment

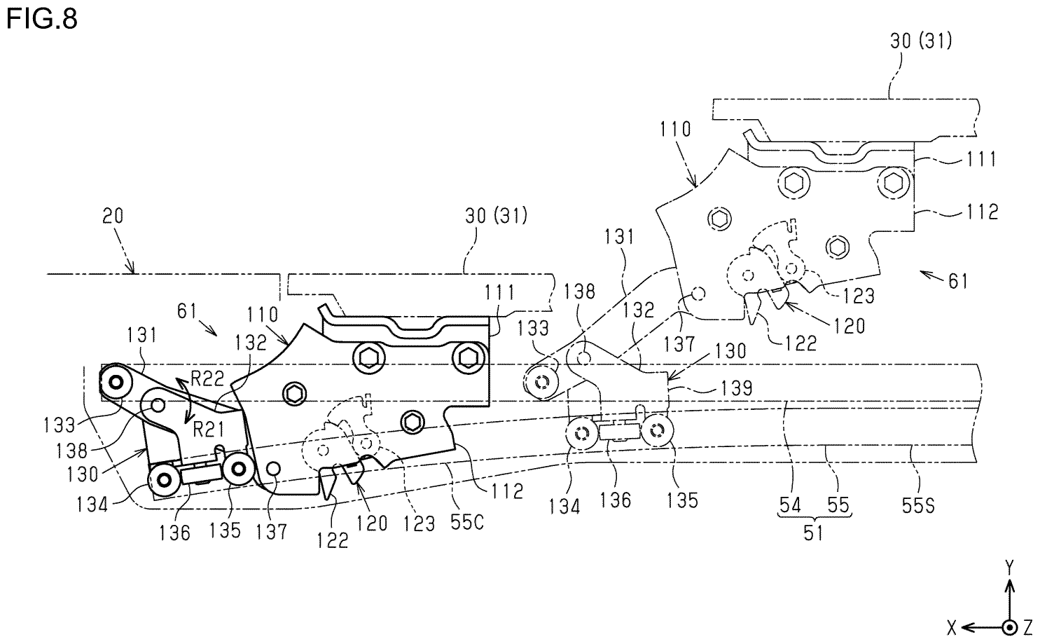

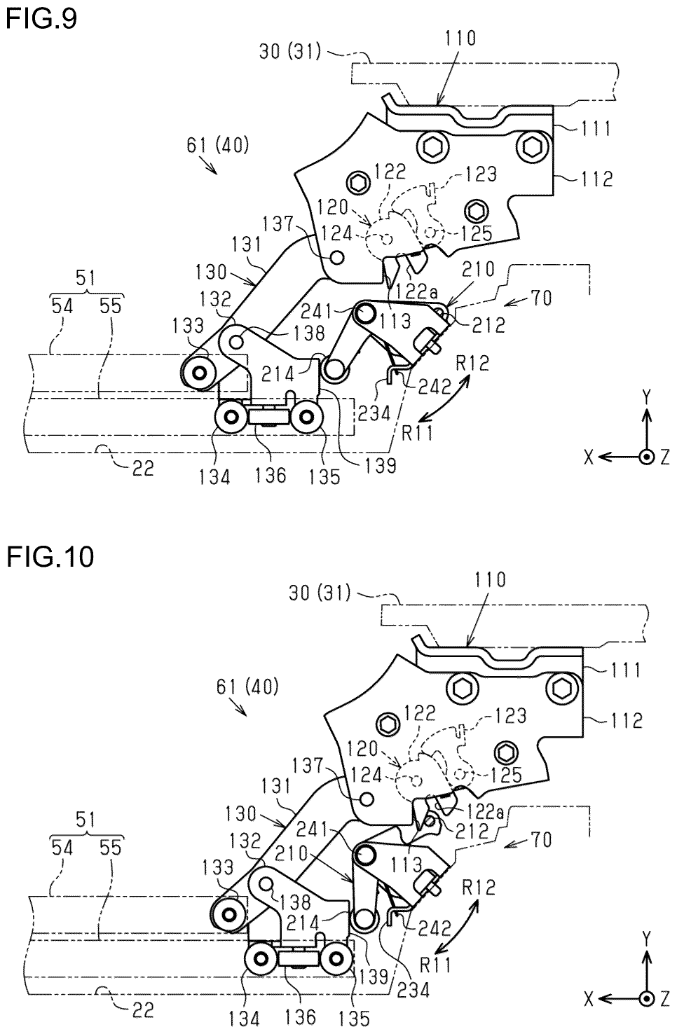

Referring to FIGS. 8 to 12, the action of the slide door 30 when the action of the slide door 30 performs the opening operation from the fully closed position is explained. In FIGS. 9 to 12, a portion of the striker 210 is broken off for ease of explanation and understanding.

When the slide door 30 is located at the fully closed position, the upper hinge unit 63 is located near the front end of the upper rail 53, the center hinge unit 62 is located near the front end of the center rail 52, and the lower hinge unit 61 is located near the front end of the lower rail 51. FIG. 8 illustrates the lower hinge unit 61 with a solid line when the slide door 30 is located at the fully closed position. As illustrated with a solid line in FIG. 8, in the lower hinge unit 61, the connecting arm 131 is most rotated in the first rotational direction R21 relative to the roller support 132. In other words, in the width direction, the tip of the connecting arm 131 has moved most inward relative to the base end of the connecting arm 131. On the other hand, as illustrated in FIG. 2, in the striker unit 70, the striker 210 is located at the retracted position where the striker 210 is most rotated in the first rotational direction R11 relative to the striker support part 220. In other words, the striker shaft 212 is located inward in the width direction than the opening of the door opening 21. The striker 210 located at the retracted position is away from the slide door 30 located at the fully closed position.

When the door drive device 80 causes the slide door 30 to perform the opening operation from the fully closed position, the lower hinge unit 61, center hinge unit 62, and upper hinge unit 63 move backward. As illustrated in FIG. 8 with dash-dot-dot lines, when the lower hinge unit 61 moves backward, the first guide roller 133 moves backward along the first rail 54, as well as, the two second guide rollers 134, 135 move backward along the second rail 55. Thus, as the two second guide rollers 134, 135 move outward in the width direction, the two second guide rollers 134, 135 gradually approach the first guide roller 133. Therefore, when the lower hinge unit 61 moves backward, the connecting arm 131 rotates in the second rotational direction R22 relative to the roller support 132. As a result, the door bracket 110 moves outward in the width direction while moving backward.

The connecting arm 131 rotates relative to the roller support 132 when the two second guide rollers 134, 135 move along the curved section 55C of the second rail 55. On the other hand, the connecting arm 131 does not rotate relative to the roller support 132 when the two second guide rollers 134, 135 move along the straight section 55S of the second rail 55. As such, when the second guide roller 134 located on the front side reaches the boundary between the curved section 55C and the straight section 55S of the second rail 55 during the opening operation of the slide door 30, the connecting arm 131 no longer rotates. In other words, the door bracket 110 does not change the position in the width direction.

As illustrated in FIG. 9, when the lower hinge unit 61 moves to near the back end of the lower rail 51, the pressing part 139 of the roller support 132 of the lower hinge unit 61 becomes in contact with the striker 210 located at the retracted position. As the lower hinge unit 61 continues to move backward, the pressing part 139 of the roller support 132 presses the receiving part 214 of the striker 210 backward. As a result, the striker 210 rotates from the retracted position in the second rotational direction R12.

As illustrated in FIG. 10, when the lower hinge unit 61 moves further backward, the lock mechanism 120 that is moving backward contacts the striker 210 that is rotating in the second rotational direction R12. Specifically, the latch 122 that is moving backward contacts the striker shaft 212 that is rotating in the second rotational direction R12. Then, as the lower hinge unit 61 moves backward, the striker 210 rotates toward the deployed position and the latch 122 rotates toward the full latch position. When the latch 122 rotates toward the full latch position, the latch spring 126 is elastically deformed. In addition, the rotating latch 122 and the pole 123 slide against each other. Furthermore, the striker shaft 212 enters the engagement groove 122a of the latch 122 and also moves toward the bottom of the engagement groove 122a of the latch 122.

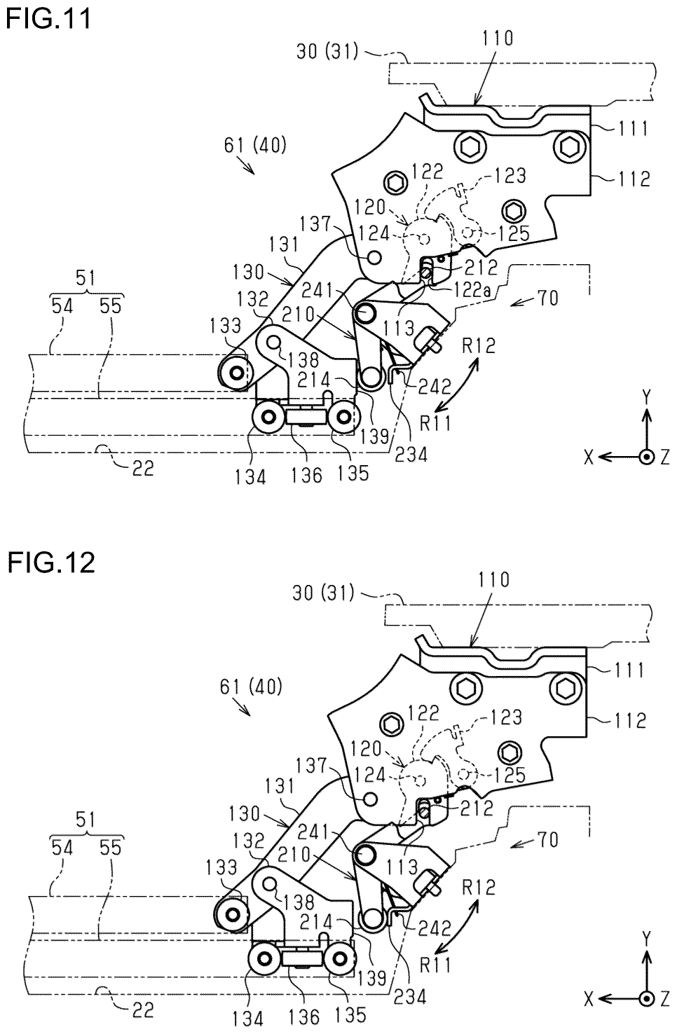

As illustrated in FIG. 11, when the lower hinge unit 61 moves further backward, the striker 210 rotates to the deployed position. Then, the latch 122 rotates to the full latch position, and the pole 123 engages with the latch 122 located at the full latch position. Thus, the latch 122 remains engaged with the striker 210. As such, even if the door drive device 80 no longer applies a load in the opening direction to the slide door 30, the slide door 30 is still restrained at the fully open position. Here, when the striker 210 is located at the deployed position, the striker shaft 212 is displaced outward in the width direction than when the striker 210 is located at the retracted position. In this respect, it can be said that the striker 210 is deployed outward in the width direction at the deployed position than at the retracted position.

If the slide door 30 continues to move after the latch 122 has rotated to the full latch position, the rotation regulating part 113 of the door bracket 110 contacts the striker shaft 212. At this time, the striker 210 attempts to rotate in the second rotational direction R12 by the force of the pressing part 139 of the roller support 132 pressing the receiving part 214 backward. Thus, a forward force acts on the contact point of the rotation regulating part 113 of the door bracket 110 with the striker shaft 212. In other words, a forward force acts on the lower hinge unit 61 that moves backward. In this way, the backward movement of the lower hinge unit 61 is restricted.

In the first embodiment, the slide door 30 is set to move in the closing direction due to the dead weight of the slide door 30 even when the vehicle 10 is stopped on a level road surface. Such a setting can be achieved, for example, by the inclination of the lower rail 51, center rail 52 and upper rail 53. Therefore, when the door drive device 80 no longer transmits power to the slide door 30, the slide door 30 attempts to move in the closing direction from the fully open position.

In this case, as illustrated in FIG. 12, when the latch 122 presses the striker shaft 212 of the striker 210 forward, the striker 210 attempts to rotate in the second rotational direction R12. However, the striker 210 can only rotate slightly in the second rotational direction R12 because the receiving part 214 of striker 210 contacts the regulating wall 234 of the striker support part 220. In other words, when the vehicle 10 is stopped on a level road surface or when the vehicle 10 is stopped on a descent, the receiving part 214 of the striker 210 and the regulating wall 234 of the striker support part 220 are in contact. That is, the slide door 30 is fixed in the position.

The action of the slide door 30 in the closing operation is briefly described. When the slide door 30 performs the closing operation from the fully open position, the door handle 32 of the slide door 30 is operated. The release cable 128 is then pulled, causing the pole 123 to rotate away from the latch 122. As a result, the latch 122 can rotate in the direction of the force of the latch spring 126. In other words, the latch 122 rotates from the full latch position toward the unlatch position, thereby releasing the restraint of the slide door 30. In this way, the slide door 30 can move in the closing direction.

When the slide door 30 performs the closing operation from the fully open position, the lower hinge unit 61, center hinge unit 62, and upper hinge unit 63 move forward. As the lower hinge unit 61 moves forward, when the pressing part 139 of the lower hinge unit 61 moves away from the receiving part 214 of the striker unit 70, the striker 210 can rotate in the first rotational direction R11. In other words, as the lower hinge unit 61 moves forward, the striker 210 rotates in the first rotational direction R11 toward the retracted position.

When the lower hinge unit 61 moves forward, if the two second guide rollers 134, 135 move along the straight section 55S of the second rail 55, the position of the door bracket 110 in the width direction does not change. On the other hand, when the two second guide rollers 134, 135 move along the curved section 55C of the second rail 55, the connecting arm 131 gradually rotates in the first rotational direction R21 relative to the roller support 132. In other words, the position of the door bracket 110 in the width direction gradually moves inward. The closing operation of the slide door 30 is completed when the lower hinge unit 61 moves to near the front end of the lower rail 51.

### Effects of the First Embodiment

(1-1) In a comparative case where the striker 210 is not displaced against the vehicle body 20, the support position of the latch 122 in the lower hinge unit 61 must be inward in the width direction in order to enable the latch 122 to engage with the striker 210. In this case, the housing space 22 tends to be longer in the width direction to avoid interference between the lower hinge unit 61 and the vehicle body 20. In other words, it tends to become difficult to install a large battery under the floor of the vehicle 10. In this respect, in the above embodiment, the striker 210 is displaced between the deployed position in which the striker 210 is deployed from the vehicle body 20 and the retracted position in which the striker 210 is stored in the vehicle body 20. Thus, compared to the comparative example, the latch 122 can be engaged with the striker 210 without setting the support position of the latch 122 in the lower hinge unit 61 inward in the width direction. Therefore, the door support device 40 can avoid interference between the lower hinge unit 61 and the vehicle body 20 without making the housing space 22 longer in the width direction. Thus, the door support device 40 can easily provide space under the floor of the vehicle 10 for installing a large battery or the like.
(1-2) The striker 210 is displaced between the deployed position and the retracted position by rotating about the axis line of the support shaft 241. Thus, the sliding resistance of the striker 210 when the striker 210 is displaced tends to be smaller than in a configuration in which the striker 210 is displaced between the deployed position and the retracted position by sliding of the striker 210. Therefore, the door support device 40 can smoothly displace the striker 210 between the deployed position and that retracted position.
(1-3) The striker unit 70 has the energizing member 242 that energizes the striker 210 from the deployed position toward the retracted position. As such, when no external force acts on the striker 210, the striker 210 is placed at the retracted position. Thus, the door support device 40 can prevent the slide door 30 from interfering with the striker 210 when the slide door 30 performs the closing operation. The guide mechanism 130 of the lower hinge unit 61 also has the pressing part 139 that presses the striker 210 backward to rotate the striker 210 from the retracted position to the deployed position when the slide door 30 moves in the opening direction. Therefore, the door support device 40 can place the striker 210 at the retracted position in conjunction with the opening operation of the slide door 30.
(1-4) The striker 210 has a receiving part 214 with a lower elastic modulus than a metallic material at the portion that is pressed by the pressing part 139 of the lower hinge unit 61 during the opening operation of the slide door 30. In this way, the sound and impact when the pressing part 139 of the lower hinge unit 61 contacts the striker 210 are mitigated.
(1-5) When the slide door 30 is located at the fully closed position, the latch 122 of the lower hinge unit 61 engages with the striker shaft 212 of the striker 210. As such, when the slide door 30 located at the fully open position attempts to move in the closing direction, the latch 122 presses the striker shaft 212 forward, causing the striker 210 to rotate. As a result, the receiving part 214 of the striker 210 contacts the regulating wall 234 of the striker support part 220, restricting the rotation of the striker 210. Thus, even when the slide door 30 is set to move in the closing direction due to the dead weight, the posture of the slide door 30 is easily maintained.
(1-6) Consider a comparative example where the receiving part 214 of the striker 210 is not rotatable about the axis line of the fixed shaft 213. In this comparative example, when the pressing part 139 of the lower hinge unit 61 presses the receiving part 214 of the striker 210, sliding resistance can occur between the pressing part 139 and the receiving part 214. In this respect, the receiving part 214 of the striker 210 according to the first embodiment is rotatable about the axis line of the fixed shaft 213. When the pressing part 139 of the lower hinge unit 61 presses the receiving part 214 of the striker 210, the receiving part 214 of the striker 210 rotates. This reduces the sliding resistance that can occur between the pressing part 139 and the receiving part 214.
(1-7) The energizing member 242 has a coil part 242a through which the support shaft 241 that rotatably supports the striker 210 is placed. Therefore, the energizing member 242 can efficiently apply force to the striker 210 in the first rotational direction R11.
(1-8) When the slide door 30 is located at the fully closed position, as well as, the striker 210 is located at the retracted position, the striker 210 is away from the slide door 30. In addition, the striker 210 is energized in the first rotational direction R11, which is the direction away from the slide door 30, by the energizing member 242. Therefore, the door support device 40 can suppress a striking noise generated by the striker 210 contacting the slide door 30 due to vibrations generated while the vehicle 10 is in motion.

### Second Embodiment

The door support device 40A according to a second embodiment is described below. Many of the component parts of the door support device 40A according to the second embodiment are the same as those of the door support device 40 according to the first embodiment. For this reason, in the description of the second embodiment, component parts that are common to the first embodiment are given the same names or signs and omitted from the description.

### Configuration of the Second Embodiment

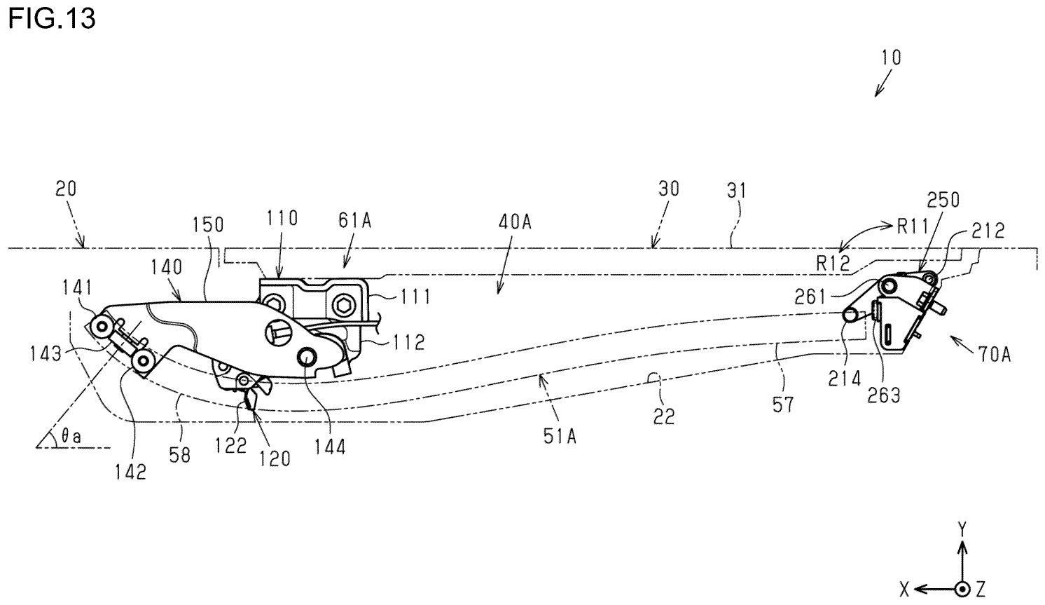

As illustrated in FIG. 13, the door support device 40A includes a lower rail 51A, a lower hinge unit 61A, and a striker unit 70A. The door support device 40A also has a center rail 52 and an upper rail 53, a center hinge unit 62, and an upper hinge unit 63.

### Lower Rail 51A

The lower rail 51A is a long member. The long direction of the lower rail 51A is the front-back direction. The lower rail 51A has a first curved section 57 constituting a back portion and a second curved section 58 constituting a front portion.

The first curved section 57 curves inward in the width direction as the first curved section 57 advances forward. The second curved section 58 curves outward in the width direction as the second curved section 58 advances forward from the front end of the first curved section 57. The long direction at the back end of the first curved section 57 is along the front-back direction. On the other hand, the long direction at the front end of the second curved section 58 is a direction that intersects the front-back direction. In the front-back direction, the length of the first curved section 57 is longer than the length of the second curved section 58. The radius of curvature of the first curved section 57 is larger than the radius of curvature of the second curved section 58. When a curve is drawn along the first curved section 57, the curve includes an inflection point in the middle portion of the curve in the front-back direction. On the other hand, when a curve is drawn along the second curved section 58, the curve does not include an inflection point in the middle portion of the curve in the front-back direction. In a state where the lower rail 51A is fixed to the vehicle body 20, the front end of the second curved section 58 is located at a position advanced forward from the back end of the first curved section 57. Although omitted from the illustration, the lower rail 51A has a configuration corresponding to the support plate 56.

### Lower Hinge Unit 61A

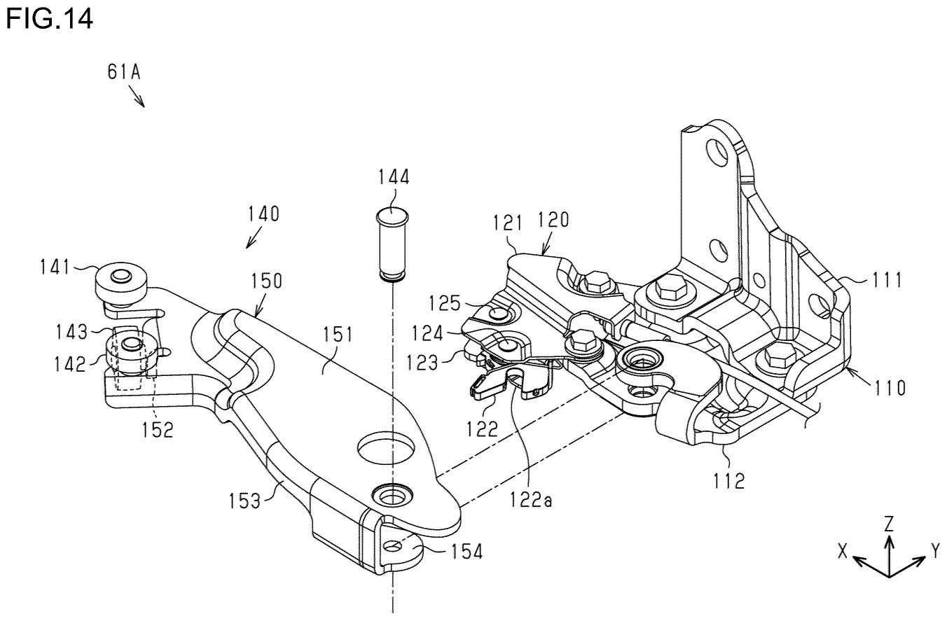

As illustrated in FIGS. 13 and 14, the lower hinge unit 61A includes a door bracket 110, a lock mechanism 120, and a guide mechanism 140. The guide mechanism 140 includes a movable arm 150, two guide rollers 141, 142, a support roller 143, and a connecting shaft 144.

As illustrated in FIG. 14, the movable arm 150 has a main wall 151, a support wall 152, a side wall 153, and a lower wall 154. The movable arm 150 is constructed, for example, by press-processing a metal sheet. In this respect, the main wall 151, support wall 152, side wall 153 and lower wall 154 are plate-shaped.

The thickness direction of the main wall 151 is the up-down direction. The main wall 151 has an elongated shape. The main wall 151 rotatably supports two guide rollers 141, 142 at the base end. The support wall 152 is bent downward from the base end of the main wall 151. In a plan view in the up-down direction, the support wall 152 is located between the portions supporting the two guide rollers 141, 142 in the main wall 151. The support wall 152 rotatably supports the support roller 143. The side wall 153 is bent downward from one of the two side ends of the main wall 151. The thickness direction of the side wall 153 is orthogonal to the thickness direction of the main wall 151. The lower wall 154 is bent downward from the lower end of the side wall 153. The thickness direction of the lower wall 154 is the same direction as the thickness direction of the main wall 151. The lower wall 154 is opposed to the tip of the main wall 151 in the up-down direction.

The connecting shaft 144 connects the main wall 151 and the lower wall 154 of the movable arm 150 to the door bracket 110. Here, the main wall 151 and the lower wall 154 of the movable arm 150 sandwich the door bracket 110 from both sides in the up-down direction. Thus, the movable arm 150 is rotatable relative to the door bracket 110 about the axis line of the connecting shaft 144. The movable arm 150, together with the door bracket 110, constitutes a hinge.

As illustrated in FIG. 13, the two guide rollers 141, 142 and support roller 143 of the guide mechanism 140 of the lower hinge unit 61A are engaged with the lower rail 51A. At this time, the two guide rollers 141, 142 and support roller 143 of the guide mechanism 140 are aligned in the long direction of the lower rail 51A. As the two guide rollers 141, 142 and support roller 143 roll against the lower rail 51A, the lower hinge unit 61A can move along the lower rail 51A. In the following description, the angle formed between the axis line of rotation of the support roller 143 and a straight line extending in the front-back direction is referred to as “the angle θa of the movable arm 150.”

### Striker Unit 70A

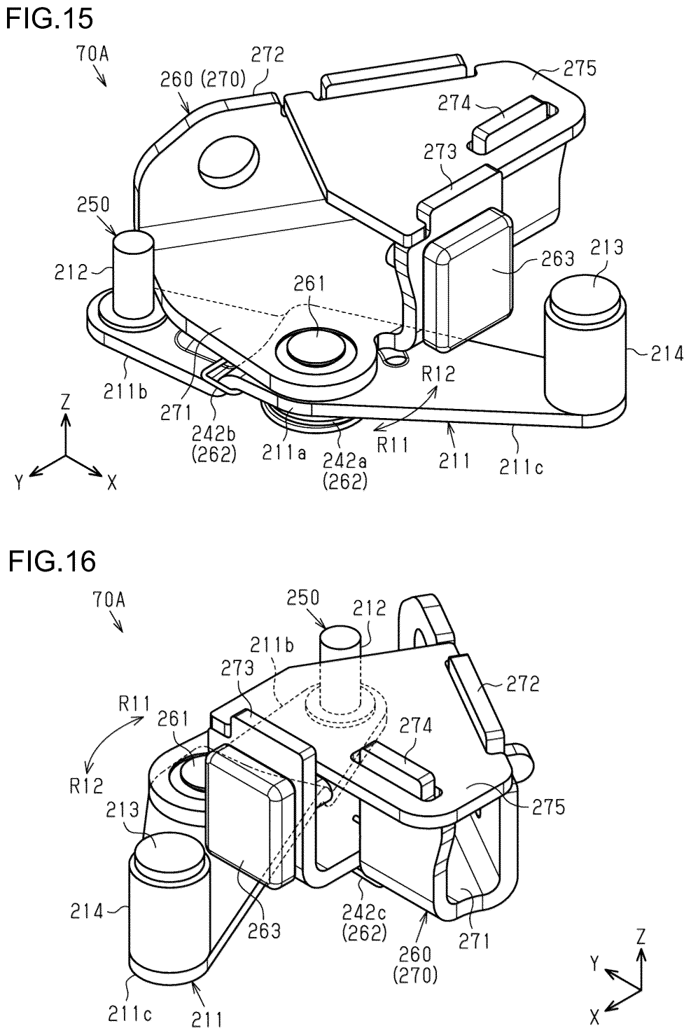

As illustrated in FIGS. 15 and 16, the striker unit 70A includes a striker 250 and a striker support part 260.

The striker 250 has a link 211, a striker shaft 212, a fixed shaft 213, and a receiving part 214. The striker shaft 212 is fixed to the tip of the first arm 211b of the link 211. The axial direction of the striker shaft 212 is the thickness direction of the first arm 211b. The base end of the striker shaft 212 is a fixed end, and the tip of the striker shaft 212 is a free end. The fixed shaft 213 is fixed to the tip of the second arm 211c of the link 211. The axial direction of the fixed shaft 213 is the thickness direction of the second arm 211c. The base end of the fixed shaft 213 is a fixed end, and the tip of the fixed shaft 213 is a free end. The receiving part 214 is supported by the fixed shaft 213. The receiving part 214 is preferably rotatable about the axis line of the fixed shaft 213.

The striker support part 260 has a support bracket 270, a support shaft 261, an energizing member 262, and a shock absorbing part 263. The support bracket 270 has a lower wall 271, a fixed wall 272, a first regulating wall 273, a second regulating wall 274, and an upper wall 275. The lower wall 271, fixed wall 272, first regulating wall 273, second regulating wall 274, and upper wall 275 are all plate-shaped. In the second embodiment, the lower wall 271, the fixed wall 272, the first regulating wall 273, and the second regulating wall 274 are constructed as a single unit, and the upper wall 275 is constructed separately from the lower wall 271, fixed wall 272, first regulating wall 273, and second regulating wall 274.

The thickness direction of the lower wall 271 is the up-down direction. The fixed wall 272, the first regulating wall 273, and the second regulating wall 274 extend upward from the side end of the lower wall 271. In this respect, the thickness direction of the fixed wall 272, the first regulating wall 273, and the second regulating wall 274 is orthogonal to the up-down direction. Space exists between the fixed wall 272 and the first regulating wall 273, and space exists between the fixed wall 272 and the second regulating wall 274. The thickness direction of the first regulating wall 273 and the thickness direction of the second regulating wall 274 are the same direction. In these thickness directions, the first regulating wall 273 and the second regulating wall 274 are misaligned. The thickness direction of the upper wall 275 is the same direction as the thickness direction of the lower wall 271. The upper wall 275 is opposed to the lower wall 271 in the up-down direction. The upper wall 275 connects the upper end of the fixed wall 272, the upper end of the first regulating wall 273, and the upper end of the second regulating wall 274.

The support shaft 261 has a cylindrical shape. The axial direction of the support shaft 261 is the up-down direction. The support shaft 261 connects the lower wall 271 of the support bracket 270 and the link 211 of the striker 250 in a relatively rotatable manner. Thus, the striker 250 can rotate relative to the support bracket 270 about the axis line of the support shaft 261. The link 211 of the striker 250 is located below the lower wall 271 of the support bracket 270.

The energizing member 262 is a torsion spring. The energizing member 262 has a coil part 242a through which the support shaft 261 is placed. The first end 242b of the energizing member 262 is engaged with the striker 250, and the second end 242c of the energizing member 262 is engaged with the support bracket 270. In this way, the energizing member 262 energizes the striker 250 in the first rotational direction R11. The striker 250, which is energized in the first rotational direction R11, is fixed in the position by contacting the lower wall 271 of the support bracket 270.

The shock absorbing part 263 is constructed of a viscoelastic elastomer such as rubber and resin. The shock absorbing part 263 has a rectangular plate shape. The shock absorbing part 263 is fixed to the first regulating wall 273 of the striker support part 260. The method of fixing the shock absorbing part 263 to the first regulating wall 273 can be selected as appropriate. For example, the shock absorbing part 263 may be fixed to the first regulating wall 273 by inserting an insertion portion provided in the shock absorbing part 263 into a fixing hole provided in the first regulating wall 273. Alternatively, the shock absorbing part 263 may be fixed to the first regulating wall 273 using a bolt or other fastening members.

As illustrated in FIG. 13, the striker unit 70A is fixed to the vehicle body 20 so that the striker unit 70A is located behind the lower rail 51A. In the striker 250, the first arm 211b of the link 211 extends inward in the width direction as the first arm 211b advances backward, while the second arm 211c of the link 211 extends inward in the width direction as the second arm 211c advances forward. The striker unit 70A is located at the same height as the lock mechanism 120 of the lower hinge unit 61A.

### Action of the Second Embodiment

Referring to FIGS. 13, 17 to 22, the action of the opening operation of the slide door 30 from the fully closed position is described with a focus on the lower hinge unit 61A.

As illustrated in FIG. 13, when the slide door 30 is located at the fully closed position, the lower hinge unit 61A is located near the front end of the lower rail 51A. At this time, the axis line of the connecting shaft 144 is located behind the axis lines of rotation of both of the two guide rollers 141, 142, and also located inward in the width direction from the axis line of rotation of the guide roller 141 that is located in front. The door bracket 110 of the lower hinge unit 61A is located most forward and most inward in the width direction in the range of its movement. The angle θa of the movable arm 150 is the smallest angle within the movable angular range.

In the striker unit 70A, the striker 250 is located at the retracted position most rotated in the first rotational direction R11 relative to the striker support part 260. In other words, the striker shaft 212 is located inward in the width direction than the opening of the door opening 21. The striker 250 located at the retracted position is away from the slide door 30 located at the fully closed position.

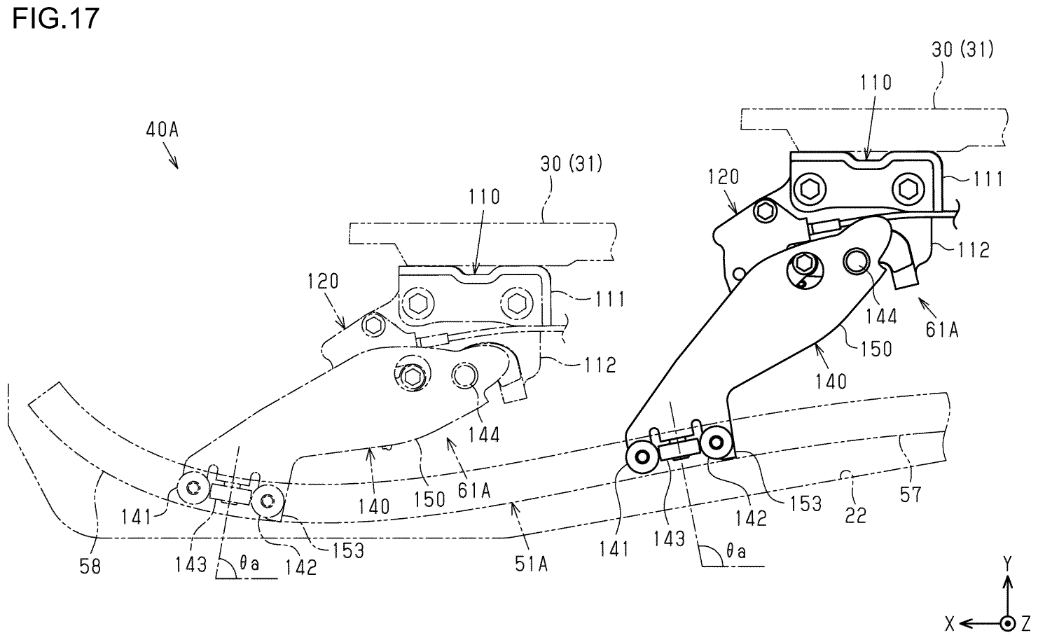

When the door drive device 80 causes the slide door 30 to perform the opening operation from the fully closed position, the lower hinge unit 61A moves backward along the lower rail 51A. As illustrated in single dotted lines in FIG. 17, when the two guide rollers 141, 142 move along the second curved section 58 of the lower rail 51A, the positional relationship of the two guide rollers 141, 142 in the width direction changes. Specifically, the axis line of rotation of the guide roller 141 located in the front moves inward in the width direction relative to the axis line of rotation of the guide roller 142 located in the back. As a result, the angle θa of the movable arm 150 becomes larger. Thus, the two guide rollers 141, 142 move inward in the width direction as the two guide rollers 141, 142 move backward along the second curved section 58 of the lower rail 51A, while the door bracket 110 moves outward in the width direction as the door bracket 110 moves backward.

As the lower hinge unit 61A continues to move backward, the two guide rollers 141, 142 end moving along the second curved section 58 of the lower rail 51A and begin moving along the first curved section 57 of the lower rail 51A.

When the two guide rollers 141, 142 move along the front end of the first curved section 57 of the lower rail 51A, the positional relationship of the two guide rollers 141, 142 in the width direction changes. Specifically, the axis line of rotation of the guide roller 141 located in the front moves inward in the width direction relative to the axis line of rotation of the guide roller 142 located in the back. As a result, the angle θa of the movable arm 150 becomes larger. Then, as illustrated in solid lines in FIG. 17, when the two guide rollers 141, 142 move along the middle portion of the first curved section 57 of the lower rail 51A, the positional relationship of the two guide rollers 141, 142 in the width direction does not change much. As such, the angle θa of the movable arm 150 does not change much either. On the other hand, when the two guide rollers 141, 142 move along the front end and the middle portion of the first curved section 57 of the lower rail 51A, the two guide rollers 141, 142 move outward in the width direction as they move backward. As a result, the door bracket 110 moves outward in the width direction as the door bracket 110 moves backward.

When the two guide rollers 141, 142 subsequently move along the back end of the first curved section 57 of the lower rail 51A, the positional relationship of the axis lines of the two guide rollers 141, 142 in the width direction changes slightly. Specifically, the axis line of rotation of the guide roller 141 located in the front moves slightly outward in the width direction relative to the axis line of rotation of the guide roller 142 located in the back. As a result, the angle θa of the movable arm 150 becomes slightly smaller. On the other hand, the two guide rollers 141, 142 move slightly outward in the width direction as the two guide rollers 141, 142 move backward. As a result, the door bracket 110 moves almost backward.

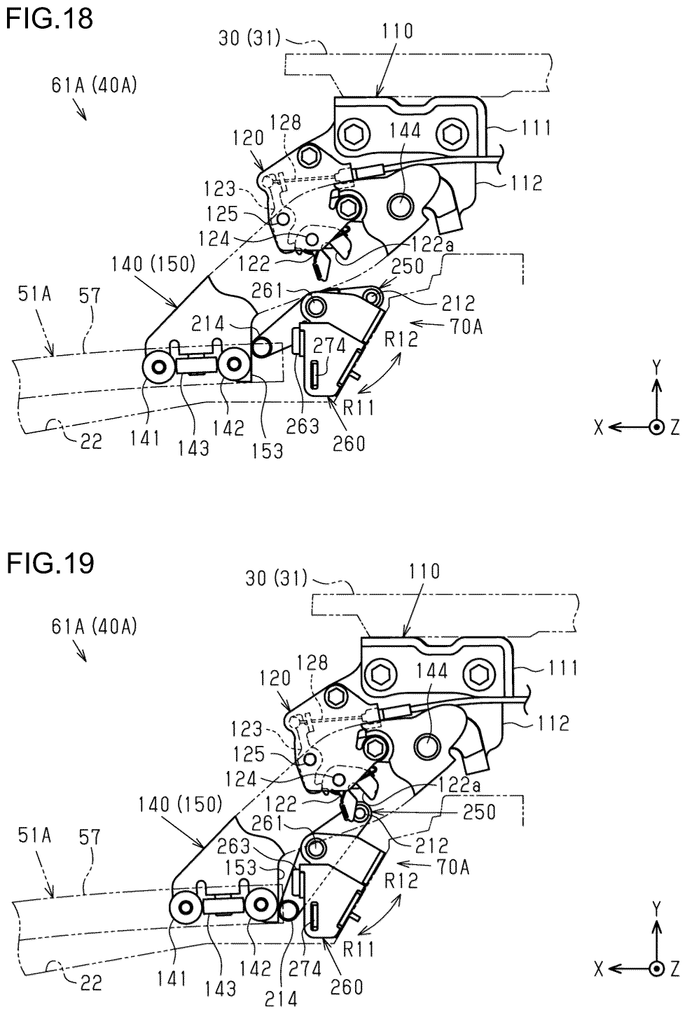

As illustrated in FIG. 18, when the lower hinge unit 61A moves to near the back end of the lower rail 51A, the movable arm 150 of the lower hinge unit 61A contacts the striker 250 located at the retracted position. As the lower hinge unit 61A continues to move backward, the movable arm 150 presses the receiving part 214 of the striker 250 backward. As a result, the striker 250 rotates from the retracted position in the second rotational direction R12. The striker 250 continues to rotate in the second rotational direction R12 while being pressed by the movable arm 150.

As illustrated in FIG. 19, when the lower hinge unit 61A moves further backward, the lock mechanism 120, which is moving backward, contacts the striker 250 rotating in the second rotational direction R12. Specifically, the latch 122 moving backward contacts the striker shaft 212 rotating in the second rotational direction R12. As the lower hinge unit 61A moves backward, the striker 250 rotates toward the deployed position, as well as, the latch 122 rotates toward the full latch position. When the latch 122 rotates toward the full latch position, the latch spring 126 is elastically deformed. In addition, the rotating latch 122 and pole 123 slide against each other. Furthermore, the striker shaft 212 enters the engagement groove 122a of the latch 122 and also moves toward the bottom of the engagement groove 122a of the latch 122.

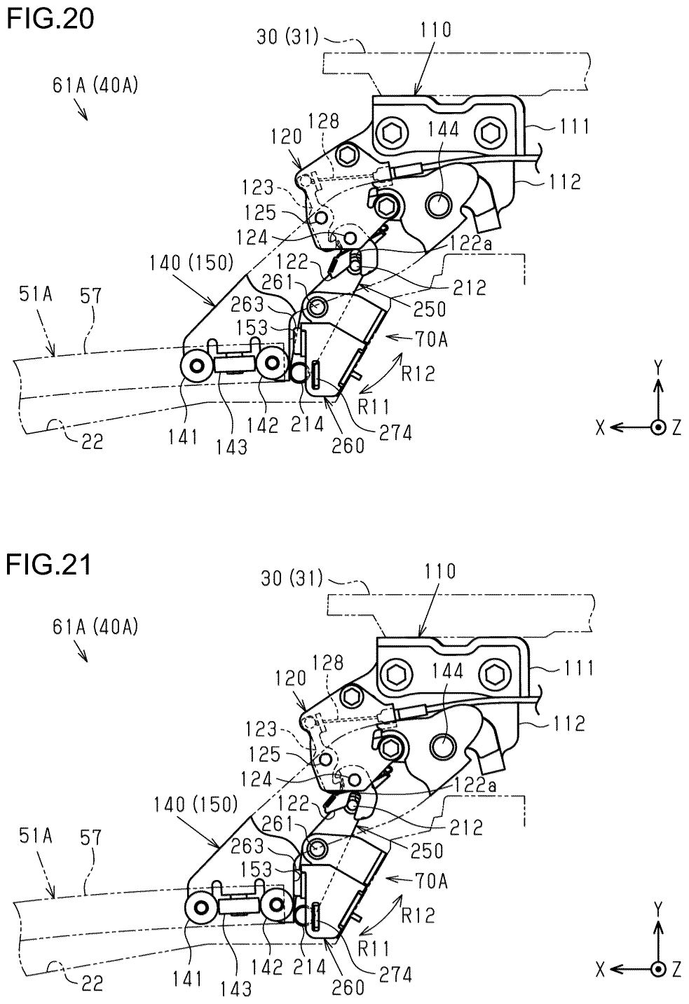

As illustrated in FIG. 20, when the lower hinge unit 61A moves further backward, the striker 250 rotates to the deployed position. In addition, the latch 122 rotates to the full latch position, and the pole 123 engages with the latch 122 in the full latch position. Thus, the latch 122 remains engaged with the striker 250. Therefore, even if the door drive device 80 no longer applies a load in the opening direction to the slide door 30, the slide door 30 is still restrained at the fully open position. Here, when the striker 250 is at the deployed position, the striker shaft 212 is displaced outward in the width direction more than when the striker 250 is located at the retracted position. In this respect, it can be said that the striker 250 is deployed outward in the width direction at the deployed position than in the retracted position.

As illustrated in FIG. 21, if the slide door 30 continues to move in the opening direction after the latch 122 has rotated to the full latch position, the movable arm 150 of the lower hinge unit 61A contacts the shock absorbing part 263 of the striker unit 70A. As such, the shock caused by the contact between the lower hinge unit 61A and the striker unit 70A is absorbed by the shock absorbing part 263. Furthermore, the backward movement of the lower hinge unit 61A is restricted.

In the second embodiment, the slide door 30 is set to move in the closing direction due to the dead weight of the slide door 30, even when the vehicle 10 is stopped on a level surface. Such a setting can be achieved, for example, by the inclination of the lower rail 51A, center rail 52, and upper rail 53. Therefore, when the door drive device 80 no longer transmits power to the slide door 30, the slide door 30 attempts to move from the fully open position in the closing direction.

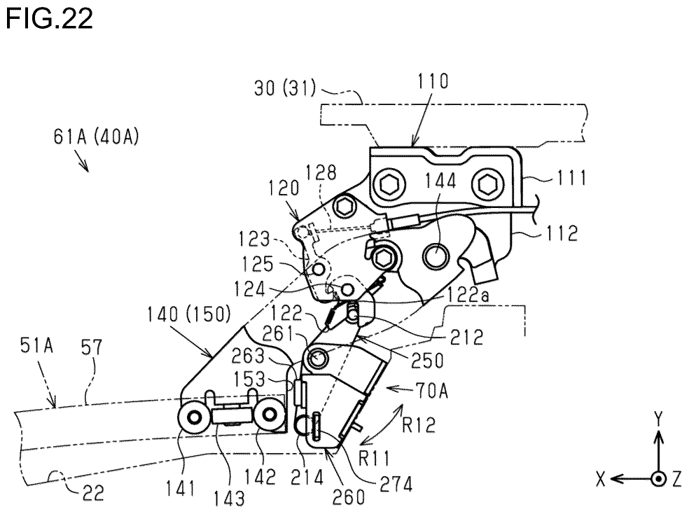

In this case, as illustrated in FIG. 22, the latch 122 presses the striker shaft 212 of the striker 250 forward, causing the striker 250 to attempt to rotate in the second rotational direction R12. However, the striker 250 cannot rotate in the second rotational direction R12 because the receiving part 214 of the striker 250 contacts the second regulating wall 274 of the striker support part 260. Thus, as long as the latch 122 is engaged with the striker 250, the slide door 30 will not move from the fully open position in the closing direction.

The action of the slide door 30 in the closing operation is briefly described. When the slide door 30 performs the closing operation from the fully open position, the door handle 32 of the slide door 30 is operated. The release cable 128 is then pulled, causing the pole 123 to rotate away from the latch 122. As a result, the latch 122 can rotate in the direction of the force of the latch spring 126. In other words, the latch 122 rotates from the full latch position toward the unlatch position, thereby releasing the restraint of the slide door 30. Thus, the slide door 30 can move in the closing direction.

When the slide door 30 performs the closing operation from the fully open position, the lower hinge unit 61A moves forward. As the lower hinge unit 61A moves forward, the movable arm 150 of the lower hinge unit 61A moves away from the receiving part 214 of the striker unit 70A, enabling the striker 250 to rotate in the first rotational direction R11. In other words, as the lower hinge unit 61A moves forward, the striker 250 rotates in the first rotational direction R11 toward the retracted position. When the lower hinge unit 61A moves forward, the door bracket 110 moves forward, as well as, inward in the width direction, contrary to when the lower hinge unit 61A moves backward. The closing operation of the slide door 30 is completed when the lower hinge unit 61A moves to near the front end of the lower rail 51A.

### Effect of the Second Embodiment

The second embodiment can obtain effects equivalent to the effects of the first embodiment. Additionally, the second embodiment can obtain the following effects.
(2-1) The striker unit 70A is equipped with a shock absorbing part 263 that absorbs impact associated with contact with the lower hinge unit 61A. Therefore, when the slide door 30 performs the opening operation, the door support device 40A can suppress generation of sound associated with contact between the lower hinge unit 61A and the striker unit 70A and suppress excessive force acting on the striker unit 70A.
(2-2) The door support device 40A can simplify the configuration of the lower rail 51A in that the lower rail 51A is configured with a single rail.

### Variation

The above embodiments can be implemented with the following modifications. The above embodiments and the following variations can be implemented in combination with each other to the extent that they are technically consistent.
The first rail 54 of the lower rail 51 can be omitted. In other words, the lower rail 51 can be configured with a single rail. In this case, the configuration of the lower hinge unit 61 may be changed to match the change in the configuration of the lower rail 51. The degree of curvature of the second rail 55 can be changed as appropriate.
The upper hinge unit 63 may have a lock mechanism 120. In this case, the striker unit 70 is preferably provided near the upper end, as well as, near the back end of the door opening 21. In other words, the striker unit 70 is preferably provided at the same height as the lock mechanism 120 of the variation. According to this, the space in the upper part of the car compartment can be suppressed from becoming narrower in the width direction.
In the striker unit 70, the energizing member 242 may energize the striker 210 from the retracted position to the deployed position. In this case, the slide door 30 preferably has a second pressing part that rotates the striker 210 to the retracted position by pressing the striker 210 located at the deployed position during the closing operation. Since the striker 210 can be rotated to the deployed position by the force of the energizing member 242, the pressing part 139 of the guide mechanism 130 of the lower hinge unit 61 can be omitted.
In the striker unit 70, the energizing member 242 for energizing the striker 210 can be omitted. In this case, the slide door 30 preferably has the pressing part 139 of the above embodiment and the second pressing part of the above variation. According to this, at the time of the opening operation of the slide door 30, the striker 210 rotates to the deployed position by being pressed by the pressing part 139. On the other hand, at the time of the closing operation of the slide door 30, the striker 210 rotates to the retracted position by being pressed by the second pressing part.
The manner in which the striker 210 moves between the deployed position and the retracted position can be modified as appropriate. For example, the striker unit 70 can be configured such that the striker 210 is linearly displaced between the deployed position and the retracted position. In this case, the striker unit 70 preferably has a mechanism for moving the striker shaft 212 outward in the width direction when the striker 210 is pressed backward by the pressing part 139 of the guide mechanism 130.
In the striker unit 70, the shape and material of the receiving part 214 can be changed as appropriate. For example, the material of the receiving part 214 may be a metallic material or a resin material.
When the slide door 30 is at the fully open position, the pressing part 139 of the lower hinge unit 61 and the regulating wall 234 of the striker support part 220 may sandwich the receiving part 214 of the striker 210 in the front-back direction. In this case, the slide door 30 is more firmly restrained at the fully open position.
In the striker unit 70, the regulating wall 234 of the striker support part 220 may be a regulating part made of rubber, resin, or the like. In the striker unit 70, the regulating wall 234 of the striker support part 220 can be omitted.
In the above embodiment, when the slide door 30 performs the opening operation, the timing at which the latch 122 contacts the striker shaft 212 is earlier than the timing at which the striker 210 reaches the deployed position. In the variation, the timing at which the latch 122 contacts the striker shaft 212 may be after the timing at which the striker 210 reaches the deployed position. In other words, the latch 122 may be configured to contact the striker 210 that is fixed at the deployed position.
The structure of the lock mechanism 120 and the structure of the striker 210 can be modified as appropriate, as long as the lock mechanism 120 can restrain the slide door 30 to the vehicle body 20 by engaging with the striker 210.

### Technical Idea

The technical idea that can be grasped from the above embodiments and variations are described.
[Aspect 1] A door support device being applied to a vehicle including a vehicle body with a door opening on a side in a width direction, and a slide door that opens and closes the door opening, wherein the slide door opens and closes the door opening by moving between a fully closed position of fully closing the door opening and a fully open position that is displaced from the fully closed position outward in the width direction and in a front-back direction and fully opens the door opening, the door support device comprising:
   a striker unit to be installed in the vehicle body;
   a door bracket extending inward in the width direction from the slide door; and
   a lock mechanism to be supported by the door bracket,
   wherein the striker unit includes a striker to be displaced between a retracted position where the striker is stored against the vehicle body and a deployed position where the striker is deployed outward in the width direction from the retracted position, the striker being placed at the retracted position when the slide door is located at the fully closed position and at the deployed position when the slide door is located at the fully open position, and the lock mechanism restrains the slide door to the vehicle body by engaging the striker located at the deployed position when the slide door is located at the fully open position.
[Aspect 2] The door support device according to aspect 1, wherein the striker unit includes a striker support part that rotatably supports the striker, and the striker rotates between the deployed position and the retracted position.
[Aspect 3] The door support device according to aspect 2, further including:
   a guide mechanism that is supported by the door bracket and moves along a guide rail installed in the vehicle body when the slide door opens and closes the door opening, wherein
      the striker unit includes an energizing member for energizing the striker from the deployed position toward the retracted position, and
      the guide mechanism includes a pressing part that, when the slide door moves in an opening direction of the slide door, rotates the striker from the retracted position to the deployed position by pressing the striker in the opening direction.
[Aspect 4] The door support device according to aspect 3, wherein
   the striker has a receiving part to be pressed by the pressing part when the slide door moves in the opening direction, and
   the receiving part is rotatable about an axis line extending in the same direction as an axis line of rotation of the striker.
[Aspect 5] The door support device according to aspect 3 or aspect 4, wherein
   the striker support part includes a support shaft that rotatably supports the striker, and
   the energizing member is a torsion spring with a coil part through which the support shaft is placed.
[Aspect 6] The door support device according to any one of aspects 1 to 5, wherein, when the slide door is located at the fully closed position and the striker is located at the retracted position, the striker is away from the slide door.
[Aspect 7] The door support device according to any one of aspects 1 to 6, wherein
   the door bracket extends from the bottom of the slide door, and
   the striker unit is placed at the same height as the lock mechanism in the vehicle body.
[Aspect 8] The door support device according to any one of aspects 3 to 5, wherein the striker includes a striker shaft with which the lock mechanism engages, and a receiving part to be pressed by the pressing part, and the receiving part is constituted of a material having a lower elastic modulus than a metallic material.
[Aspect 9] The door support device according to aspect 8, wherein the striker support part includes a regulating part that sandwiches the receiving part together with the pressing part in the front-back direction when the slide door is located at the fully closed position.
[Aspect 10] The door support device according to any one of aspects 3 to 5, wherein the striker support part includes a shock absorbing part that absorbs shock at a portion that contacts the guide mechanism when the slide door continues to move in the opening direction after the striker rotates to the deployed position.

A door support device that solves the problem described above is a door support device applied to a vehicle including a vehicle body with a door opening on a side in a width direction, and a slide door that opens and closes the door opening, wherein the slide door opens and closes the door opening by moving between a fully closed position of fully closing the door opening and a fully open position that is displaced from the fully closed position outward in the width direction and in a front-back direction and fully opens the door opening, the door support device includes a striker unit to be installed in the vehicle body, a door bracket extending inward in the width direction from the slide door, and a lock mechanism to be supported by the door bracket, the striker unit includes a striker to be displaced between a retracted position where the striker is stored against the vehicle body and a deployed position where the striker is deployed outward in the width direction from the retracted position, the striker is placed at the retracted position when the slide door is located at the fully closed position and at the deployed position when the slide door is located at the fully open position, and the lock mechanism restrains the slide door to the vehicle body by engaging with the striker located at the deployed position when the slide door is located at the fully open position.

The door support device can suppress narrowing of space in the width direction of the vehicle due to the door support device.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door support device being applied to a vehicle including a vehicle body with a door opening on a side in a width direction, and a slide door that opens and closes the door opening, wherein the slide door opens and closes the door opening by moving between a fully closed position of fully closing the door opening and a fully open position that is displaced from the fully closed position outward in the width direction and in a front-back direction and fully opens the door opening, the door support device comprising:
a striker unit to be installed in the vehicle body;
a door bracket extending inward in the width direction from the slide door; and
a lock mechanism to be supported by the door bracket,
wherein the striker unit includes a striker to be displaced between a retracted position where the striker is stored against the vehicle body and a deployed position where the striker is deployed outward in the width direction from the retracted position, the striker being placed at the retracted position when the slide door is located at the fully closed position and at the deployed position when the slide door is located at the fully open position, and
the lock mechanism restrains the slide door to the vehicle body by engaging with the striker located at the deployed position when the slide door is located at the fully open position.

2. The door support device according to claim 1, wherein
the striker unit includes a striker support part that rotatably supports the striker, and
the striker rotates between the deployed position and the retracted position.

3. The door support device according to claim 2, further comprising:
a guide mechanism that is supported by the door bracket and moves along a guide rail installed in the vehicle body when the slide door opens and closes the door opening, wherein
the striker unit includes an energizing member for energizing the striker from the deployed position toward the retracted position, and
the guide mechanism includes a pressing part that, when the slide door moves in an opening direction of the slide door, rotates the striker from the retracted position to the deployed position by pressing the striker in the opening direction.

4. The door support device according to claim 3, wherein
the striker includes a receiving part to be pressed by the pressing part when the slide door moves in the opening direction, and
the receiving part is rotatable about an axis line extending in the same direction as an axis line of rotation of the striker.

5. The door support device according to claim 3, wherein
the striker support part includes a support shaft that rotatably supports the striker, and
the energizing member is a torsion spring with a coil part through which the support shaft is placed.

6. The door support device according to claim 1, wherein,
when the slide door is located at the fully closed position and the striker is located at the retracted position, the striker is away from the slide door.

7. The door support device according to claim 1, wherein
the door bracket extends from a bottom of the slide door, and
the striker unit is placed at the same height as the lock mechanism in the vehicle body.

8. The door support device according to claim 4, wherein
the striker support part includes a support shaft that rotatably supports the striker, and
the energizing member is a torsion spring with a coil part through which the support shaft is placed.

9. The door support device according to claim 2, wherein,
when the slide door is located at the fully closed position and the striker is located at the retracted position, the striker is away from the slide door.

10. The door support device according to claim 2, wherein
the door bracket extends from a bottom of the slide door, and
the striker unit is placed at the same height as the lock mechanism in the vehicle body.
